(19) United States
(12) Patent Application Publication
(10) Pub. No.: US 2025/0006891 A1
(43) Pub. Date: Jan. 2, 2025

(54) NEGATIVE ELECTRODE, ENERGY STORAGE DEVICE, AND ENERGY STORAGE APPARATUS

(71) Applicant: GS Yuasa International Ltd., Kyoto (JP)

(72) Inventors: Shinnosuke ICHIKAWA, Kyoto (JP); Nobuhiro NAKAJIMA, Kyoto (JP); Takashi SHIMIZU, Kyoto (JP); Akihito TANOI, Kyoto (JP); Heisuke NISHIKAWA, Kyoto (JP)

(73) Assignee: GS Yuasa International Ltd., Kyoto (JP)

(21) Appl. No.: 18/828,803

(22) Filed: Sep. 9, 2024

Related U.S. Application Data
(63) Continuation of application No. PCT/JP2023/009310, filed on Mar. 10, 2023.

(30) Foreign Application Priority Data
Mar. 10, 2022 (JP) 2022-037485

(51) Int. Cl. H01M 4/134; H01M 4/02; H01M 4/38; H01M 4/62; H01M 10/0567; H01M 10/0569

(52) U.S. Cl. CPC H01M 4/134; H01M 4/386; H01M 4/622; H01M 4/625; H01M 10/0567; H01M 10/0569; H01M 2004/027

(57) ABSTRACT

A negative electrode includes a negative active material layer containing a silicon-based negative active material, a rubber-based binder, and a carbon nanotube, wherein a content of the silicon-based negative active material in the negative active material layer is 68 mass % or more, a content of the rubber-based binder in the negative active material layer is 3.0 mass % or more, and a content of the carbon nanotube in the negative active material layer is 0.4×(n²+4n)/(2n+3) mass % or less where n is the number of layers of graphene forming the carbon nanotube.

### CROSS-REFERENCE TO RELATED APPLICATIONS

The present application is a continuation of and claims the benefit of priority to International Application No. PCT/JP2023/009310, filed Mar. 10, 2023, which is based upon and claims the benefit of priority to Japanese Application No. 2022-037485, filed Mar. 10, 2022. The entire contents of these applications are incorporated herein by reference.

### BACKGROUND OF THE INVENTION

### Field of the Invention

The present invention relates to a negative electrode, an energy storage device, and an energy storage apparatus.

### Description of Background Art

JP-A-2015-053152, JP-A-2010-212228 and JP-A-2004-356078 describe an energy storage device in which a silicon-based negative active material (a negative active material containing a silicon element, such as silicon simple substance or silicon oxide) is used as a negative active material. The entire contents of these publications are incorporated herein by reference.

### SUMMARY OF THE INVENTION

According to one aspect of the present invention, a negative electrode for an energy storage device includes a negative active material layer including a silicon-based negative active material, a rubber-based binder, and a carbon nanotube. A content of the silicon-based negative active material in the negative active material layer is 68 mass % or more, a content of the rubber-based binder in the negative active material layer is 3.0 mass % or more, and a content of the carbon nanotube in the negative active material layer is 0.4×(n²+4n)/(2n+3) mass % or less where n is a number of layers of graphene forming the carbon nanotube.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a see-through perspective view illustrating an energy storage device according to an embodiment of the present invention;

FIG. 2 is a schematic diagram illustrating an energy storage apparatus including multiple energy storage devices assembled according to an embodiment of the present invention; and

FIG. 3 is a view showing a state in which a surface of a silicon-based negative active material is coated with a carbon nanotube.

### DETAILED DESCRIPTION OF THE EMBODIMENTS

Embodiments will now be described with reference to the accompanying drawings, wherein like reference numerals designate corresponding or identical elements throughout the various drawings.

A negative electrode according to one aspect of the present invention includes a negative active material layer containing a silicon-based negative active material, a rubber-based binder, and a carbon nanotube, wherein a content of the silicon-based negative active material in the negative active material layer is 68 mass % or more, a content of the rubber-based binder in the negative active material layer is 3.0 mass % or more, and a content of the carbon nanotube in the negative active material layer is 0.4×(n²+4n)/(2n+3) mass % or less (where n is the number of layers of graphene forming the carbon nanotube.).

The negative electrode can suppress a decrease in a capacity retention ratio after a charge-discharge cycle and a decrease in high-rate discharge performance while increasing the discharge capacity of the energy storage device even when the negative electrode contains the silicon-based negative active material. The reason for this is not clear, but there may be the following reasons.

As described above, one of the reasons why the capacity retention ratio after a charge-discharge cycle is low in the conventional energy storage device using the silicon-based negative active material is that the silicon-based negative active material is greatly expanded and contracted due to charge-discharge. In addition, as the content of the silicon-based negative active material in the negative active material layer increases, the influence of expansion and contraction of the silicon-based negative active material increases, and the bonding state between the silicon-based negative active materials is likely to be impaired when charge-discharge are repeated. As a result, isolation of the silicon-based negative active material occurs, and the capacity retention ratio after a charge-discharge cycle is significantly lowered in the energy storage device.

On the other hand, in the negative electrode, the negative active material layer includes a rubber-based binder and a carbon nanotube, the content of the silicon-based negative active material in the negative active material layer is 68 mass % or more, the content of the rubber-based binder in the negative active material layer is 3.0 mass % or more, and the content of the carbon nanotube in the negative active material layer is 0.4×(n2+4n)/(2n+3) mass % or less (where n is the number of layers of graphene forming the carbon nanotube.). Since the rubber-based binder is an elastic body and is concentrated in the vicinity of a contact point with the silicon-based negative active material, a conductive agent to be described later, and the like, it is considered that the bonding state between the silicon-based negative active materials having large expansion and contraction accompanying charge-discharge can be improved. Here, it is considered that by further using a carbon nanotube as the conductive agent, the number of contact points between the silicon-based negative active material and the conductive agent increases, and isolation between the silicon-based negative active materials is suppressed. Furthermore, it is considered that by setting the content of the silicon-based negative active material to 68 mass % or more in addition to the above constitution, the silicon-based negative active materials are more suitably arranged, and the contact with the carbon nanotube as a conductive agent is more favorably maintained. As a result, it is thought that the negative electrode can suppress a decrease in the capacity retention ratio after a charge-discharge cycle and a decrease in high-rate discharge performance while increasing the discharge capacity of the energy storage device in spite of the high content of the silicon-based negative active material.

In the negative electrode, by setting the content of the rubber-based binder to 3.0 mass % or more, it is possible to enhance the effect of suppressing the decrease in the capacity retention ratio after a charge-discharge cycle and the decrease in the high-rate discharge performance of the energy storage device. On the other hand, when the negative active material layer excessively contains a carbon nanotube as a conductive agent, coating of the silicon-based negative active material with the carbon nanotube becomes excessive and inhibits the lithium-ion transfer between the nonaqueous electrolyte and the surface of the negative active material, and high-rate discharge performance is deteriorated. In the negative electrode, it is thought that when the content of a carbon nanotube in the negative active material layer is 0.4×(n²+4n)/(2n+3) mass % or less (where n is the number of layers of graphene forming the carbon nanotube.), coating of the silicon-based negative active material with the carbon nanotube is moderate and does not inhibit the lithium-ion transfer between the nonaqueous electrolyte and the surface of the negative active material, and deterioration of high rate discharge performance is suppressed. For example, when the carbon nanotube is a single-walled carbon nanotube (the number of layers of graphene is 1), it is thought that the content of the carbon nanotube is 0.4×(1²+4×1)/(2× 1+3) mass % or less, that is, 0.4 mass % or less, the coating of the silicon-based negative active material with the carbon nanotube is moderate, and the deterioration of the high rate discharge performance is suppressed.

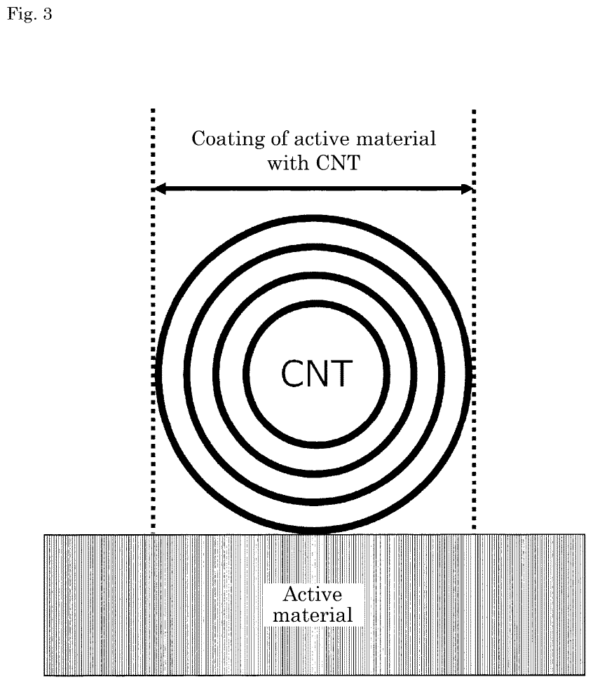

Here, the technical significance of the fact that the content of a carbon nanotube is 0.4×(n²+4n)/(2n+3) mass % or less (where n is the number of layers of graphene forming the carbon nanotube.) is described. FIG. 3 shows a state in which the surface of the silicon-based negative active material is coated with a carbon nanotube. Table 1 shows the number of layers of graphene that forms a carbon nanotube, the diameter of the carbon nanotube, the area coated with the silicon-based negative active material by the carbon nanotube of a unit length, the mass of the carbon nanotube of a unit length, and the content of the carbon nanotube in the negative active material layer that are required to have the same area coated with the silicon-based negative active material as in the case where the content of the single-walled carbon nanotube in the negative active material layer is 0.4 mass %. As shown in FIG. 3, assuming that the length of the carbon nanotube is constant, the area of the surface of the silicon-based negative active material coated with the carbon nanotube is proportional to the diameter of the carbon nanotube. Assuming that the diameter of the single-walled carbon nanotube (the number of layers of graphene is 1) is 1.7 nm and the distance between graphene layers is 0.34 nm, the diameter of the carbon nanotube formed of n-layer graphene is calculated to be 1.7+0.34×(2n−1)=0.34×(2n+3) nm. When it is estimated that the area coated with a single-walled carbon nanotube of a unit length is 1.7 nm² based on the above-mentioned assumption and FIG. 3, the area coated with a carbon nanotube formed of n-layer graphene per a unit length (for example, 1 nm) can be estimated as 0.34×(2n+3) nm² similarly. Therefore, relative values of the area coated with a carbon nanotube formed of n-layer graphene of a unit length are shown in Table 1. In addition, when it is assumed that the mass of the single-walled carbon nanotube of the unit length is 1.7, the mass of the graphene of the k-th layer (k is a natural number of n or less) counting from the center in the carbon nanotube formed of the n-layer graphene of the unit length is correlated with the diameter of the k-th layer, and can be expressed as 0.34×(2 k+3). Therefore, the mass of the carbon nanotube formed of n-layer graphene of a unit length, which is the total of the first layer to the n-th layer, can be expressed as 0.34×(n²+4 n) as shown in formula 1.

$${\sum }_{k = 1}^{n} 0.34 \times ( 2 k + 3 ) = 0.34 \times ( {n}^{2} + 4 n ) \qquad ( 1 )$$

When it is assumed that the mass of the single-walled carbon nanotube coating the unit area of the silicon-based negative active material is 1, the relative value of the mass of a carbon nanotube formed of n-layer graphene coating the unit area of the silicon-based negative active material can be calculated as (n²+4 n)/(2n+3). Therefore, the content of the carbon nanotube formed of the n-layer graphene in the negative active material layer, which is necessary for obtaining the same coated area of the silicon-based negative active material as in the case where the content of the single-walled carbon nanotube in the negative active material layer is 0.4 mass %, can be expressed as 0.4×(n²+4 n)/(2n+3) mass %. That is, when the number of layers of graphene (n) forming the carbon nanotube increases, the mass of the carbon nanotube formed of the n-layer graphene increases functionally in accordance with 0.4×(n²+4 n)/(2n+3) in order to obtain the same coated area of the silicon-based negative active material using the carbon nanotube formed of n-layer graphene as in the case where the single-walled carbon nanotube is used.

TABLE 1

| | | Area coated by CNT | Mass of CNT | Amount of CNT added to |
|---|---|---|---|---|
| Number of | | of a unit length | of a unit length | achieve same coverage |
| layers of | Diameter of | (Relative value when | (Relative value when | area as SWCNT 0.4 mass % |
| graphene | ONT (nm) | set to 1.7 at SWCNT) | set to 1.7 at SWCNT) | (mass %) |
| 1 | 1.700 | 1.700 | 1.700 | 0.400 |
| 2 | 2.380 | 2.380 | 4.080 | 0.686 |
| 3 | 3.060 | 3.060 | 7.140 | 0.933 |
| 4 | 3.740 | 3.740 | 10.880 | 1.164 |
| 5 | 4.420 | 4.420 | 15.300 | 1.385 |
| n | 0.34 × (2n + 3) | 0.34 × (2n + 3) | 0.34 × (n + 4n) | 0.4 × (n + 4n)/(2n + 3) |

In the negative electrode, the content of the carbon nanotube in the negative active material layer may be 0.4 mass % or less. In the negative electrode, it is thought that when the content of the carbon nanotube in the negative active material layer is 0.4 mass % or less, coating of the silicon-based negative active material particles with the carbon nanotube is moderate, and deterioration of high-rate discharge performance is further suppressed.

In the negative electrode, the negative active material layer may further contain a carbon-based material, and the total content of the carbon nanotube and the carbon-based material in the negative active material layer may be 22 mass % or less. In the negative electrode, by setting the total content of the carbon nanotube and the carbon-based material to the above upper limit or less, it is possible to further enhance the effect of suppressing the decrease in the capacity retention ratio after a charge-discharge cycle and the decrease in the high rate discharge performance of the energy storage device.

In JP-A-2006-196338, JP-A-2013-101921, JP-A-2017-188334, and WO2012/026462, in order to suppress the influence of expansion and contraction of the silicon-based active material or to improve the capacity retention ratio (charge-discharge cycle characteristics), the proportion of the carbon-based material such as graphite is preferably set to a certain level or more.

In particular, JP-A-2017-188334 states, “the graphite material is preferably 20 mass % or more and 80 mass % or less with respect to the total active material mass (100 mass %). When it is less than 20 mass %, the negative electrode is easily peeled off from the current collector due to the influence of the volume change of the silicon-based active material.” (paragraph 0022).

On the other hand, in the negative electrode, it is considered that since the total content of the carbon nanotube and the carbon-based material in the negative active material layer is 22 mass % or less, the silicon-based negative active materials are more suitably arranged, and the contact with the carbon nanotube as a conductive agent is more favorably maintained. As a result, it is thought that the negative electrode can suppress a decrease in the capacity retention ratio after a charge-discharge cycle and a decrease in the high-rate discharge performance while increasing the discharge capacity of the energy storage device although the content of the carbon-based material is low. The “total content of the carbon nanotube and the carbon-based material” means the total content of the carbon nanotube and the carbon-based material contained in the negative active material layer as the negative active material, the conductive agent or the like, and when the surface of the negative active material is coated with carbon, the carbon contained in the coating is included.

In the negative electrode, a content of the rubber-based binder in the negative active material layer may be 6.0 mass % or more. In the negative electrode, by setting the content of the rubber-based binder to the above lower limit or more, it is possible to further enhance the effect of suppressing the decrease in the capacity retention ratio after a charge-discharge cycle and the decrease in the high-rate discharge performance of the energy storage device.

In the negative electrode, the carbon nanotube may include a single-walled carbon nanotube. Even when the content of the single-walled carbon nanotube in the negative active material layer is small, the single-walled carbon nanotube is densely distributed in the negative active material layer, and the contact between the silicon-based negative active material of the entire negative active material layer and the single-walled carbon nanotube as a conductive agent can be suitably maintained. Therefore, in the negative electrode, the carbon nanotube includes the single-walled carbon nanotube, whereby the effect of suppressing the decrease in the capacity retention ratio after the charge-discharge cycle and the decrease in the high-rate discharge performance of the energy storage device can be further enhanced.

An energy storage device according to another aspect of the present invention includes a negative electrode according to an embodiment of the present invention. Since the energy storage device includes a negative electrode according to an embodiment of the present invention, it is possible to suppress a decrease in capacity retention ratio after a charge-discharge cycle and a decrease in high-rate discharge performance.

An energy storage apparatus according to another aspect of the present invention includes two or more energy storage devices, and one or more energy storage devices according to an embodiment of the present invention. Since the energy storage apparatus includes one or more energy storage devices according to an embodiment of the present invention, it is possible to suppress a decrease in capacity retention ratio after a charge-discharge cycle and a decrease in high-rate discharge performance.

A configuration of a negative electrode, a configuration of an energy storage device, a configuration of an energy storage apparatus, a method for manufacturing the energy storage device according to one embodiment of the present invention, and other embodiments are described in detail. The names of the respective constituent members (respective constituent elements) for use in the respective embodiments may be different from the names of the respective constituent members (respective constituent elements) for use in the background art.

### Negative Electrode

The negative electrode according to an embodiment of the present invention includes a negative substrate and a negative active material layer disposed directly on the negative substrate or over the negative substrate with an intermediate layer interposed therebetween. The negative electrode is a negative electrode used for an energy storage device such as a secondary battery.

The negative substrate has conductivity. Whether the positive substrate has “conductivity” or not is determined with the volume resistivity of 10⁻² Ω·cm measured in accordance with JIS-H-0505 (1975) as a threshold. As the material for the negative substrate, a metal such as copper, nickel, stainless steel, or nickel-plated steel, or an alloy thereof, a carbonaceous material, or the like is used. Among these metals and alloys, the copper or copper alloy is preferable. Examples of the negative substrate include a foil, a deposited film, a mesh, and a porous material, and a foil is preferable from the viewpoint of cost. Accordingly, the negative substrate is preferably a copper foil or a copper alloy foil. Examples of the copper foil include rolled copper foils and electrolytic copper foils.

The average thickness of the negative substrate is preferably 2 μm or more and 35 μm or less, more preferably 3 μm or more and 30 μm or less, still preferably 4 μm or more and 25 μm or less, and particularly preferably 5 μm or more and 20 μm or less. By setting the average thickness of the negative substrate within the above range, the energy density of the energy storage device can be increased while increasing the strength of the negative substrate.

The intermediate layer is a layer disposed between the negative substrate and the negative active material layer. The intermediate layer contains a conductive agent such as carbon particles, thereby reducing contact resistance between the negative substrate and the negative active material layer. The configuration of the intermediate layer is not particularly limited, and includes, for example, a binder and a conductive agent.

The negative active material layer contains a silicon-based negative active material, a rubber-based binder, and a carbon nanotube. The negative active material layer contains a carbon-based material other than a carbon nanotube, a conductive agent other than a carbon nanotube and carbon-based materials, a binder other than a rubber-based binder, optional components such as a thickener, and a filler as necessary.

The negative active material layer may contain typical nonmetal elements such as B, N, P, F, Cl, Br, and I, typical metal elements such as Li, Na, Mg, Al, K, Ca, Zn, Ga, Ge, Sn, Sr, and Ba, and transition metal elements such as Sc, Ti, V, Cr, Mn, Fe, Co, Ni, Cu, Mo, Zr, Ta, Hf, Nb, and W as a component other than a silicon-based negative active material, a carbon nanotube, a rubber-based binder, a carbon-based material, another conductive agent, another binder, a thickener, and a filler.

The negative active material contains a silicon-based negative active material. The silicon-based negative active material is an active material containing a silicon element. Examples of the silicon-based negative active material include a simple substance of silicon or a compound containing a silicon element. Examples of the silicon element-containing compound include silicon oxide (SiOx: 0<x<2, preferably 0.8≤x≤1.2), silicon nitride, silicon carbide, and a metal silicon compound. Examples of the metal silicon compound include compounds containing a metal element such as an aluminum element, a tin element, a zinc element, a nickel element, a copper element, a titanium element, a vanadium element, or a magnesium element and a silicon element. In addition, the silicon-based negative active material may be a composite material made of a simple substance of silicon or a compound containing a silicon element, such as a SiO/Si/SiO₂ composite material. As the silicon-based negative active material, one pre-doped with charge transport ions or metal ions of the energy storage device can also be used. That is, for example, the silicon-based negative active material may further contain an alkali metal element, an alkaline earth metal element, or the like such as a lithium element or a magnesium element. The silicon-based negative active material can be used alone, or two or more thereof can be used in mixture. Among the silicon-based negative active materials, a simple substance of silicon and silicon oxide are preferable, silicon oxide is more preferable, and silicon oxide pre-doped with a charge transport ion or a metal ion of the energy storage device is still preferable.

The silicon-based negative active material may have a surface coated with a conductive material such as carbon. The use of the silicon-based negative active material in such a form allows the electron conductivity of the negative active material layer to be enhanced. When the silicon-based negative active material is coated with the conductive material, the mass ratio of the conductive material to the total amount of the silicon-based negative active material and the conductive material coating the silicon-based negative active material is, for example, preferably 1 mass % or more and 10 mass % or less, and more preferably 2 mass % or more and 5 mass % or less.

The form of the silicon-based negative active material is not particularly limited but is preferably particulate. The average particle size of the silicon-based negative active material is, for example, preferably 1 nm or more and 50 μm or less, more preferably 1 μm or more and 40 μm or less, still preferably 3 μm or more and 30 μm or less, and still more preferably 5 μm or more and 20 μm or less. By setting the average particle size of the silicon-based negative active material to be equal to or more than the lower limit mentioned above, the silicon-based negative active material is easily manufactured or handled. By setting the average particle size of the silicon-based negative active material to the above upper limit or less, the silicon-based negative active material can sufficiently react during charge-discharge. In this regard, the term “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

The lower limit of the content of the silicon-based negative active material in the negative active material layer is 68 mass %, preferably 80 mass %, and more preferably 85 mass %. On the other hand, the upper limit of the content of the silicon-based negative active material in the negative active material layer is 96.6 mass %, and may be 96 mass %, 95 mass %, or 93 mass %. By setting the content of the silicon-based negative active material to the above lower limit or more, a higher capacity can be achieved, and the effect of suppressing a decrease in the capacity retention ratio after a charge-discharge cycle is excellent.

The negative active material layer may further contain a negative active material other than the silicon-based negative active material. Examples of such other negative active materials include known negative active materials usually used in a lithium secondary battery and the like, and examples thereof include a carbon-based material, a Sn or Sn oxide, a titanium-containing oxide, a polyphosphoric acid compound, and the like.

Among these materials, a carbon-based material is preferably contained. Examples of the carbon-based material include graphite and non-graphitic carbon. One of these materials may be used alone, or two or more of these materials may be used in combination.

The term “graphite” refers to a carbon-based material in which an average grid spacing (d₀₀₂) of a (002) plane determined by X-ray diffraction before charge-discharge or in a discharged state is 0.33 nm or more and less than 0.34 nm. Examples of the graphite include natural graphite and artificial graphite. Artificial graphite is preferable from the viewpoint that a material having stable physical properties can be obtained.

The term “non-graphitic carbon” refers to a carbon-based material in which the average grid spacing (d₀₀₂) of a (002) plane determined by X-ray diffraction before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material.

In this regard, the “discharged state” means a state discharged such that lithium ions that can be occluded and released in association with charge-discharge are sufficiently released from the carbon-based material as the negative active material. For example, the “discharged state” refers to a state where the open circuit voltage is 0.7 V or higher in a half cell that has, for use as a working electrode, a negative electrode containing a carbon-based material as a negative active material and has metal Li for use as a counter electrode.

The “hardly graphitizable carbon” refers to a carbon-based material in which the door is 0.36 nm or more and 0.42 nm or less.

The “easily graphitizable carbon” refers to a carbon-based material in which the door is 0.34 nm or more and less than 0.36 nm.

The other negative active material mentioned above is typically particles (powder). When the other negative active material is a carbon-based material, a titanium-containing oxide, or a polyphosphoric acid compound, the average particle size thereof may be 1 μm or more and 100 μm or less. When the other negative active material is Sn, a Sn oxide or the like, the average particle size thereof may be 1 nm or more and 1 μm or less. By setting the average particle size of the other negative active material to be equal to or more than the lower limit, the negative active material is easily manufactured or handled. By setting the average particle size of the other negative active material to the above upper limit or less, the electron conductivity of the negative active material layer is improved.

A crusher, a classifier, or the like is used in order to obtain a powder with a predetermined particle size. Examples of the crushing method include a method of using a mortar, a ball mill, a sand mill, a vibratory ball mill, a planetary ball mill, a jet mill, a counter jet mill, a whirling airflow-type jet mill, a sieve, or the like. At the time of crushing, wet-type crushing in coexistence of water or an organic solvent such as hexane can also be used. As a classification method, a sieve or a wind force classifier or the like is used based on the necessity both in dry manner and in wet manner. The content of all the negative active materials in the negative active material layer is 68 mass % or more and 96.6 mass % or less, preferably 68 mass % or more and 96 mass % or less, more preferably 80 mass % or more and 95 mass % or less, and more preferably 85 mass % or more and 93 mass % or less. By setting the content of the negative active material within the above range, it is possible to achieve both high energy density of the negative active material layer and an improvement in an effect of suppressing a decrease in capacity retention ratio after a charge-discharge cycle. The upper limit of the content of the silicon-based negative active material with respect to all the negative active materials in the negative active material layer is not particularly limited, and may be, for example, 100 mass %.

The negative active material layer contains a carbon nanotube (CNT). The carbon nanotube is graphene-based carbon and is a component that functions as a conductive agent in the negative active material layer. It is considered that when the negative active material layer contains the carbon nanotube, the number of contact points between the silicon-based negative active material and the conductive agent increases in the negative electrode, and isolation between the silicon-based negative active materials is suppressed. Examples of the carbon nanotube include a single-walled carbon nanotube (SWCNT) formed of a single layer of graphene and multi-walled a carbon nanotube (MWCNT) formed of two or more layers (e.g. 2 to 20 layers, typically 2 to 60 layers) of graphene. Among them, SWCNT is particularly preferable because it is densely distributed in the negative active material layer even when the content in the negative active material layer is small, and the contact between the silicon-based negative active material of the entire negative active material layer and the single-walled carbon nanotube as a conductive agent can be suitably maintained. Therefore, from the viewpoint of further enhancing the effect of suppressing the decrease in the capacity retention ratio after a charge-discharge cycle and the decrease in the high-rate discharge performance of the energy storage device, it is preferable that the carbon nanotube contains a single-walled carbon nanotube, and it is more preferable that the carbon nanotube consists of only a single-walled carbon nanotube. The structure of the graphene-based carbon is not particularly limited and may be any of a chiral (helical) type, a zigzag type, and an armchair type. In addition, it may contain a catalyst metal element (for example, an iron element, a cobalt element, and a platinum group element (ruthenium element, rhodium element, palladium element, osmium element, iridium element, and platinum element)) or the like used for synthesis of a carbon nanotube. The fact that the negative active material layer contains a carbon nanotube can be confirmed by observation with an electron microscope. The fact that the negative active material layer contains a single-walled carbon nanotube can be confirmed by observation with a transmission electron microscope (TEM) or observation of a peak corresponding to RBM (radial breathing mode) in Raman spectroscopy. The number of layers of a carbon nanotube can be confirmed by observation with a transmission electron microscope (TEM).

The lower limit of the content of the carbon nanotube in the negative active material layer is preferably 0.025×(n²+4n)/(2n+3) mass % (where n is the number of layers of graphene forming the carbon nanotube.), more preferably 0.05×(n²+4n)/(2n+3) mass %, still preferably 0.10×(n2+4n)/(2n+3) mass %. By setting the content of the carbon nanotube to the above lower limit or more, it is possible to enhance the effect of suppressing the decrease in the discharge capacity of the energy storage device, the capacity retention ratio after a charge-discharge cycle, and the high rate discharge performance. On the other hand, the upper limit of the content of a carbon nanotube in the negative active material layer is 0.4×(n2+4n)/(2n+3) mass %, preferably 0.3×(n²+4n)/(2n+3) mass %. By setting the content of the carbon nanotube to the above upper limit or less, the cost can be reduced, the content of the negative active material in the negative active material layer can be increased to have a high capacity, and deterioration of high-rate discharge performance can be suppressed.

The content of the single-walled carbon nanotube in the negative active material layer is preferably 0.025 mass % or more, more preferably 0.05 mass % or more, and still preferably 0.10 mass % or more. By setting the content of the single-walled carbon nanotube to the above lower limit or more, it is possible to enhance the effect of suppressing the decrease in the discharge capacity of the energy storage device, the capacity retention ratio after a charge-discharge cycle, and the high-rate discharge performance. On the other hand, the content of the single-walled carbon nanotube in the negative active material layer is 0.4 mass % or less, preferably 0.3 mass % or less, and more preferably 0.2 mass % or less. By setting the content of the single-walled carbon nanotube to the above upper limit or less, the cost can be reduced, the content of the negative active material in the negative active material layer can be increased to have a high capacity, and deterioration of high-rate discharge performance can be suppressed.

The average diameter of the carbon nanotube is not particularly limited, but is preferably 100 nm or less, more preferably 50 nm or less, still preferably 20 nm or less, and still more preferably 10 nm or less from the viewpoint of suitably forming a conductive path of the entire negative active material layer.

The average length of the carbon nanotube is preferably 1 μm or more and 500 μm or less, more preferably 1 μm or more and 100 μm or less, still preferably 1 μm or more and 20 μm or less, from the viewpoint of easy handling, exhibiting better conductivity, and the like.

The average diameter and the average length are average values of arbitrary 10 carbon nanotubes observed with an electron microscope.

The negative active material layer contains a rubber-based binder. It is considered that when the negative active material layer contains the rubber-based binder, since the rubber-based binder is an elastic body and is concentrated in the vicinity of a contact point with the silicon-based negative active material, the conductive agent, and the like, the bonding state between the silicon-based negative active materials having large expansion and contraction accompanying charge-discharge can be improved. Examples of the rubber-based binder in the negative active material layer include styrene-butadiene rubber (SBR), ethylene-propylene-diene rubber (EPDM), sulfonated EPDM, fluororubber, and gum arabic. Among them, SBR is preferable from the viewpoint of a binding property.

As the SBR, one or two or more of SBR can be used as a binder. The SBR is a copolymer of styrene and butadiene. The SBR may be copolymerized with a monomer other than styrene and butadiene. For example, carboxy-modified SBR, acrylic acid-modified SBR (including fluorine-containing one), methyl methacrylic acid-modified SBR, or the like may be used. As a monomer composition of the SBR, a blending ratio of styrene and butadiene (styrene:butadiene) is preferably about 1:2 to 2:1. In addition, the total amount of styrene and butadiene preferably occupies 50 mass % or more (typically 75 mass % or more, for example, 90 mass % or more) of the total amount of monomers. In the preparation of the negative electrode, the SBR can be preferably used in the form of an aqueous emulsion (latex) dispersed in an aqueous solvent (typically water). As the SBR of the aspect, a SBR in which a carboxyl group is introduced into a polymer can be preferably employed. Alternatively, SBR in which substantially no monomer other than styrene and butadiene is copolymerized (The content of monomers other than styrene and butadiene is 5 mass % or less, and further 1 mass % or less with respect to the total amount of monomers.) may be used.

When the rubber-based binder has a functional group that is reactive with lithium or the like, the functional group may be deactivated by methylation or the like in advance.

The lower limit of the content of the rubber-based binder in the negative active material layer is 3.0 mass %, preferably 5.0 mass %, more preferably 6.0 mass %, and still preferably 8.0 mass %. By setting the content of the rubber-based binder to the above lower limit or more, it is possible to further enhance the effect of suppressing the decrease in the capacity retention ratio after a charge-discharge cycle and the decrease in the high-rate discharge performance of the energy storage device. On the other hand, the upper limit of the content of the rubber-based binder is preferably 15.0 mass %, more preferably 10.0 mass %, and still preferably 9.0 mass %. By setting the content of the rubber-based binder to the above upper limit or less, the content of the negative active material in the negative active material layer can be increased to achieve a high capacity.

The negative active material layer may contain a binder other than the rubber-based binder. Examples of the other binder include polyacrylate and polymethacrylate. When the negative active material layer contains a binder other than the rubber-based binder, the rubber-based binder is preferably contained as a main component of the binder. Here, the “main component” means a component having the largest content and refers to a component exceeding 50 mass % with respect to the total mass of the binder.

The negative active material layer may contain other conductive agents other than a carbon nanotube. Examples of other conductive agents include carbon-based materials other than carbon nanotubes, metals, and conductive ceramics. Examples of the carbon-based material include non-graphitic carbon and graphene-based carbon. Examples of the non-graphitic carbon include carbon nanofibers, pitch-based carbon fibers, and carbon black. Examples of the carbon black include furnace black, acetylene black, and ketjen black. Examples of the graphene-based carbon include graphene and fullerene. Examples of the form of other conductive agents include a powdery form and a fibrous form. As other conductive agents, one of these materials may be used, or two or more thereof may be used in mixture. In addition, these materials may be used in combination.

Examples of the thickener include polysaccharide polymers such as carboxymethylcellulose (CMC) and methylcellulose. When the thickener mentioned above has a functional group that is reactive with lithium and the like, the functional group may be deactivated by methylation or the like in advance.

The content of the thickener in the negative active material layer is preferably 0.3 mass % or more and 4 mass % or less, and more preferably 0.5 mass % or more and 2 mass % or less.

The filler is not particularly limited. Examples of the filler include polyolefins such as polypropylene and polyethylene, inorganic oxides such as silicon dioxide, alumina, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, and barium sulfate, nitrides such as aluminum nitride and silicon nitride, and substances derived from mineral resources, such as talc, montmorillonite, boehmite, zeolite, apatite, kaolin, mullite, spinel, olivine, sericite, bentonite and mica, or artificial products thereof.

When the negative active material layer further contains a carbon-based material, the upper limit of the total content of the carbon nanotube and the carbon-based material in the negative active material layer is preferably 22 mass %, and more preferably 10 mass %. It is considered that when the total content of the carbon nanotube and the carbon-based material in the negative active material layer is 22 mass % or less, the silicon-based negative active materials are more suitably arranged, and the contact with the carbon nanotube as a conductive agent is more favorably maintained. As a result, it is thought that the negative electrode can suppress a decrease in the capacity retention ratio after a charge-discharge cycle and a decrease in the high rate discharge performance while increasing the discharge capacity of the energy storage device although the content of the carbon-based material is low.

The negative electrode can be prepared, for example, by applying a negative composite paste to a negative substrate directly or via an intermediate layer, followed by drying. After the drying, pressing or the like may be performed, if necessary. The negative composite paste contains components constituting the negative active material layer, such as a silicon-based negative active material, a rubber-based binder, a carbon nanotube, and optional components such as other negative active materials, other conductive agents, other binders, thickeners, and fillers. The negative composite paste typically further contains a dispersion medium.

### Energy Storage Device

An energy storage device according to an embodiment of the present invention includes: an electrode assembly including a positive electrode, a negative electrode, and a separator; a nonaqueous electrolyte; and a case that houses the electrode assembly and the nonaqueous electrolyte. The electrode assembly is typically a stacked type obtained by stacking multiple positive electrodes and multiple negative electrodes with separators interposed therebetween, or a wound type obtained by winding a positive electrode and a negative electrode stacked with a separator interposed therebetween. The nonaqueous electrolyte is present in a state of being contained in the positive electrode, the negative electrode, and the separator. A nonaqueous electrolyte secondary battery (hereinafter, also referred to simply as “secondary battery”) is described as an example of the energy storage device.

### Positive Electrode

The positive electrode includes a positive substrate and a positive active material layer disposed directly on the positive substrate or over the positive substrate with an intermediate layer interposed therebetween. The configuration of the intermediate layer is not particularly limited, and for example, can be selected from the configurations exemplified for the negative electrode.

The positive substrate has conductivity. As the material of the positive substrate, a metal such as aluminum, titanium, tantalum, or stainless steel, or an alloy thereof is used. Among these metals and alloys, aluminum or an aluminum alloy is preferable from the viewpoints of electric potential resistance, high conductivity, and cost. Examples of the positive substrate include a foil, a deposited film, a mesh, and a porous material, and a foil is preferable from the viewpoint of cost. Accordingly, the positive substrate is preferably an aluminum foil or an aluminum alloy foil. Examples of the aluminum or aluminum alloy include A1085, A3003, and A1N30 specified in JIS-H-4000 (2014) or JIS-H-4160 (2006).

The average thickness of the positive substrate is preferably 3 μm or more and 50 μm or less, more preferably 5 μm or more and 40 μm or less, still preferably 8 μm or more and 30 μm or less, and particularly preferably 10 μm or more and 25 μm or less. By setting the average thickness of the positive substrate to the above range, it is possible to increase the energy density of a secondary battery while increasing the strength of the positive substrate.

The positive active material layer contains a positive active material. The positive active material layer contains optional components such as a conductive agent, a binder, a thickener, a filler, or the like as necessary.

The positive active material can be appropriately selected from known positive active materials. As the positive active material for a lithium ion secondary battery, a material capable of occluding and releasing lithium ions is typically used. Examples of the positive active material include lithium-transition metal composite oxides that have an α-NaFeO₂-type crystal structure, lithium-transition metal composite oxides that have a spinel-type crystal structure, polyanion compounds, chalcogenides, and sulfur. Examples of the lithium-transition metal composite oxides that have an α-NaFeO₂-type crystal structure include Li[LiₓNi₍₁₋ₓ₎]O₂ (0≤x<0.5), Li[LiₓNi_{γ}Co_{(1-x-γ)}]O₂ (0≤x<0.5, 0<γ<1), Li[LiₓCo₍₁₋ₓ₎]O₂ (0≤x<0.5), Li[LiₓNi_{γ}Mn_{(1-x-γ)}]O₂ (0≤x<0.5, 0<γ<1), Li[LiₓNi_{γ}Mn_{ß}Co_{(1-x-γ-ß)}]O₂ (0≤x<0.5, 0<γ, 0<ß, 0.5<γ+ß<1), and Li[LiₓNi_{γ}Co_{ß}Al_{(1-x-γ-ß)}]O₂ (0≤x<0.5, 0<γ, 0<ß, 0.5<γ+ß<1). Examples of the lithium-transition metal composite oxides that have a spinel-type crystal structure include LiₓMn₂O₄ and LiₓNi_{γ}Mn_{(2-γ)}O₄. Examples of the polyanion compounds include LiFePO₄, LiMnPO₄, LiNiPO₄, LiCOPO₄, LiBV₂(PO₄)₃, Li₂MnSiO₄, and Li₂CoPO₄F. Examples of the chalcogenides include a titanium disulfide, a molybdenum disulfide, and a molybdenum dioxide. Some of atoms or polyanions in these materials may be substituted with atoms or anion species composed of other elements. The surfaces of these materials may be coated with other materials. As the positive active material, one of these materials may be used singly, or two or more thereof may be used in mixture.

The positive active material is usually a particle (powder). The average particle size of the positive active material is preferably 0.1 μm or more and 20 μm or less, for example. The lower limit of the average particle size of the positive active material is preferably 1 μm or more, more preferably 4 μm or more, and still preferably 8 μm or more in some cases. By setting the average particle size of the positive active material to be equal to or more than the lower limit mentioned above, the positive active material is easily manufactured or handled. By setting the average particle size of the positive active material to the above upper limit or less, the positive active material sufficiently reacts during charge-discharge. It is to be noted that in the case of using a composite of the positive active material and another material, the average particle size of the composite is regarded as the average particle size of the positive active material.

A crusher, a classifier, or the like is used in order to obtain a powder with a predetermined particle size. Examples of the crushing method include a method of using a mortar, a ball mill, a sand mill, a vibratory ball mill, a planetary ball mill, a jet mill, a counter jet mill, a whirling airflow-type jet mill, a sieve, or the like. At the time of crushing, wet-type crushing in coexistence of water or an organic solvent such as hexane can also be used. As a classification method, a sieve or a wind force classifier or the like is used based on the necessity both in dry manner and in wet manner.

The lower limit of the content of the positive active material in the positive active material layer is preferably 50 mass % or more, more preferably 70 mass % or more, still preferably 80 mass % or more. The upper limit of the content of the positive active material in the positive active material layer is preferably 99.5 mass %, and more preferably 99 mass %. By setting the content of the positive active material within the above range, it is possible to achieve both high capacity and manufacturability of the positive electrode.

The conductive agent is not particularly limited as long as the agent is a material with conductivity. Examples of such a conductive agent include carbonaceous materials, metals, and conductive ceramics. Examples of the carbonaceous materials include graphite, non-graphitic carbon, and graphene-based carbon. Examples of the non-graphitic carbon include carbon nanofibers, pitch-based carbon fibers, and carbon black. Examples of the carbon black include furnace black, acetylene black, and ketjen black. Examples of the graphene-based carbon include graphene, CNT, and fullerene. Examples of the form of the conductive agent include a powdery form and a fibrous form. As the conductive agent, one of these materials may be used alone, or two or more thereof may be used in mixture. In addition, these materials may be used in combination. For example, a composite material of carbon black and CNT may be used. Among them, carbon black or CNT is preferable from the viewpoint of electron conductivity and coatability, a combination of carbon black and CNT is more preferable, and a combination of carbon black and SWCNT is still preferable.

The content of the conductive agent in the positive active material layer is preferably 0.1 mass % or more and 10 mass % or less, and more preferably 0.2 mass % or more and 5 mass % or less. By setting the content of the conductive agent within the above range, the energy density of the secondary battery can be increased while ensuring the conductivity of the positive electrode.

Examples of the binder mentioned above include: thermoplastic resins such as fluororesins (e.g., polytetrafluoroethylene (PTFE), polyvinylidene fluoride (PVDF)), polyethylene, polypropylene, polyacryl, and polyimide; elastomers such as an ethylene-propylene-diene rubber (EPDM), sulfonated EPDM, a styrene butadiene rubber (SBR), and a fluororubber; and polysaccharide polymers.

The content of the binder in the positive active material layer is preferably 0.4 mass % or more and 10 mass % or less, and more preferably 0.8 mass % or more and 5 mass % or less. By setting the content of the binder to the above range, the positive active material can be stably held. When SWCNT is used as the conductive agent, the content of the binder can be further reduced, and the upper limit thereof can be 2 mass % or less.

The thickener and the filler can be selected from the materials exemplified for the negative electrode.

The positive active material layer may contain a typical nonmetal element such as B, N, P, F, Cl, Br, and I, a typical metal element such as Li, Na, Mg, Al, K, Ca, Zn, Ga, Ge, Sn, Sr, and Ba, or a transition metal element such as Sc, Ti, V, Cr, Mn, Fe, Co, Ni, Cu, Mo, Zr, Nb, and W as a component other than the positive active material, the conductive agent, the binder, the thickener, and the filler.

### Negative Electrode

The negative electrode provided in the energy storage device is the above-described negative electrode as the negative electrode according to an embodiment of the present invention. In the energy storage device including the negative electrode, in order to further increase the energy density of the energy storage device, the mass per unit area of the positive active material layer and the negative active material layer is increased, whereby the discharge capacity per unit area can be increased. From the viewpoint of further increasing the energy density of the energy storage device, the discharge capacity per unit area of the positive electrode is preferably 3.5 mAh/cm2 or more, more preferably 4.0 mAh/cm2 or more, and still preferably 4.5 mAh/cm2 or more. The area of the positive electrode is the area of the positive active material layer disposed opposite to the negative active material layer. When the positive active material layer is disposed on both surfaces of the positive substrate, the total (XA+XB) of the area XA of the positive active material layer disposed opposite to the negative active material layer on one surface and the area XB of the positive active material layer disposed opposite to the negative active material layer on the other surface is defined as the area of the positive electrode.

### Separator

The separator can be appropriately selected from known separators. As the separator, for example, a separator composed of only a substrate layer, a separator in which a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, a porous resin film is preferable from the viewpoint of strength, and a nonwoven fabric is preferable from the viewpoint of liquid retaining properties of the nonaqueous electrolyte. As the material for the substrate layer of the separator, for example, a polyolefin such as polyethylene or polypropylene is preferable from the viewpoint of shutdown function, and polyimide, aramid or the like is preferable from the viewpoint of resistance to oxidative decomposition. As the substrate layer of the separator, a material obtained by combining these resins may be used.

The heat resistant particles contained in the heat resistant layer preferably have a mass loss of 5% or less when the temperature is raised from room temperature to 500° C. in the air atmosphere of 1 atm, and still preferably have a mass loss of 5% or less when the temperature is raised from room temperature to 800° C. Examples of materials that have a mass loss equal to or less than a predetermined value include inorganic compounds. Examples of the inorganic compound include oxides such as iron oxide, silicon oxide, aluminum oxide, titanium dioxide, zirconium oxide, calcium oxide, strontium oxide, barium oxide, magnesium oxide and aluminosilicate; nitrides such as aluminum nitride and silicon nitride; carbonates such as calcium carbonate; sulfates such as barium sulfate; hardly soluble ionic crystals such as calcium fluoride, barium fluoride, barium titanate; covalently bonded crystals such as silicon and diamond; and substances derived from mineral resources, such as talc, montmorillonite, boehmite, zeolite, apatite, kaolin, mullite, spinel, olivine, sericite, bentonite, and mica, and artificial products thereof. As the inorganic compounds, simple substances or complexes of these substances may be used alone, or two or more thereof may be used in mixture. Among these inorganic compounds, silicon oxide, aluminum oxide, or aluminosilicate is preferable from the viewpoint of safety of the energy storage device.

A porosity of the separator is preferably 80% by volume or less from the viewpoint of strength and is preferably 20% by volume or more from the viewpoint of discharge performance. The term “porosity” herein is a volume-based value, and means a value measured using a mercury porosimeter.

As the separator, a polymer gel composed of a polymer and a nonaqueous electrolyte may be used. Examples of the polymer include a polyacrylonitrile, a polyethylene oxide, a polypropylene oxide, a polymethyl methacrylate, a polyvinyl acetate, a polyvinylpyrrolidone, and a polyvinylidene fluoride. The use of the polymer gel has the effect of suppressing liquid leakage. As the separator, a polymer gel may be used in combination with a porous resin film, a nonwoven fabric, or the like as described above.

### Nonaqueous Electrolyte

The nonaqueous electrolyte can be appropriately selected from publicly known nonaqueous electrolytes. For the nonaqueous electrolyte, a nonaqueous electrolyte solution may be used. The nonaqueous electrolyte solution contains a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, those in which some hydrogen atoms contained in these compounds are substituted with halogen may be used.

Examples of the cyclic carbonates include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among them, FEC is preferable.

Examples of the chain carbonate include diethyl carbonate (DEC), dimethyl carbonate (DMC), ethyl methyl carbonate (EMC), diphenyl carbonate, 2-fluoroethyl methyl carbonate, 2,2-difluoroethyl methyl carbonate, 2,2,2-trifluoroethyl methyl carbonate, and bis(trifluoroethyl) carbonate. Among them, 2,2,2-trifluoroethyl methyl carbonate (TFEMC) or ethyl methyl carbonate (EMC) is preferable.

As the nonaqueous solvent, it is preferable to use the cyclic carbonate or the chain carbonate, and it is more preferable to use the cyclic carbonate and the chain carbonate in combination. The use of the cyclic carbonate allows the promoted dissociation of the electrolyte salt to improve the ionic conductivity of the nonaqueous electrolyte solution. The use of the chain carbonate allows the viscosity of the nonaqueous electrolyte solution to be kept low. In a case where a cyclic carbonate and a chain carbonate are used in combination, a volume ratio of the cyclic carbonate to the chain carbonate (cyclic carbonate:chain carbonate) is preferably in a range from 5:95 to 50:50, for example.

The electrolyte salt can be appropriately selected from known electrolyte salts. Examples of the electrolyte salt include a lithium salt, a sodium salt, a potassium salt, a magnesium salt, and an onium salt. Among these, a lithium salt is preferable.

Examples of the lithium salt include inorganic lithium salts such as LiPF₆, LiPO₂F₂, LiBF₄, LiClO₄, and LiN(SO₂F)₂, lithium oxalates such as lithium bis(oxalate) borate (LiBOB), lithium difluorooxalatoborate (LiFOB), and lithium bis(oxalate)difluorophosphate (LiFOP), and lithium salts having a halogenated hydrocarbon group, such as LiSO:CF₃, LiN(SO₂CF₃)₂, LiN(SO₂C₂F₅)₂, LiN(SO₂CF₃)(SO₂C₄F₉), LiC(SO₂CF₃)₃, and LiC(SO₂C₂F₅)₃. Among these salts, the inorganic lithium salts are preferable, and LiPF₆ is more preferable. One or two or more of the electrolyte salts can be used.

The content of the electrolyte salt in the nonaqueous electrolyte solution is, at 20° C. under 1 atm, preferably 0.1 mol/dm³ or more and 2.5 mol/dm³ or less, more preferably 0.4 mol/dm³ or more and 2.0 mol/dm³ or less, and still preferably 0.7 mol/dm³ or more and 1.7 mol/dm³ or less. The content of the electrolyte salt falls within the range mentioned above, thereby allowing the ionic conductivity of the nonaqueous electrolyte solution to be increased.

The nonaqueous electrolyte solution may include an additive, besides the nonaqueous solvent and the electrolyte salt. Examples of the additive include oxalic acid salts such as lithium bis(oxalate) borate (LiBOB), lithium difluorooxalatoborate (LiFOB), and lithium bis(oxalate)difluorophosphate (LiFOP); imide salts such as lithium bis(fluorosulfonyl)imide (LiFSI); aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds, such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexanedicarboxylic anhydride; ethylene sulfite, propylene sulfite, dimethyl sulfite, methyl methanesulfonate, busulfan, methyl toluenesulfonate, dimethyl sulfate, ethylene sulfate, sulfolane, dimethyl sulfone, diethyl sulfone, dimethylsulfoxide, diethylsulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, 1,3-propene sultone, 1,3-propane sultone, 1,4-butane sultone, 1,4-butene sultone, perfluorooctane, tristrimethylsilyl borate, tristrimethylsilyl phosphate, tetrakistrimethylsilyl titanate, lithium monofluorophosphate, and lithium difluorophosphate. One of these additives may be used alone, or two or more thereof may be used in mixture.

The content of the additive contained in the nonaqueous electrolyte solution is preferably 0.01 mass % or more and 10 mass % or less, more preferably 0.1 mass % or more and 7 mass % or less, and still preferably 0.2 mass % or more and 5 mass % or less with respect to the total mass of the nonaqueous electrolyte solution. The content of the additive falls within the range mentioned, thereby making it possible to improve capacity retention performance or cycle performance after high-temperature storage, and to further improve safety.

As the nonaqueous electrolyte, a solid electrolyte may be used, or a nonaqueous electrolyte solution and a solid electrolyte may be used in combination.

The solid electrolyte can be selected from arbitrary materials with ionic conductivity, which are solid at normal temperature (for example, 15° C. to 25° C.), such as lithium, sodium, and calcium. Examples of the solid electrolyte include a sulfide solid electrolyte, an oxide solid electrolyte, a nitride solid electrolyte, a polymer solid electrolyte, and a gel polymer electrolyte.

Examples of the lithium ion secondary battery include Li₂S—P₂S₅, LiI—Li₂S—P₂S₅, and Li₁₀Ge—P₂S₁₂ as the sulfide solid electrolyte.

The shape of the energy storage device according to the present embodiment is not particularly limited, and examples thereof include cylindrical batteries, laminated batteries, prismatic batteries, flat batteries, coin batteries and button batteries.

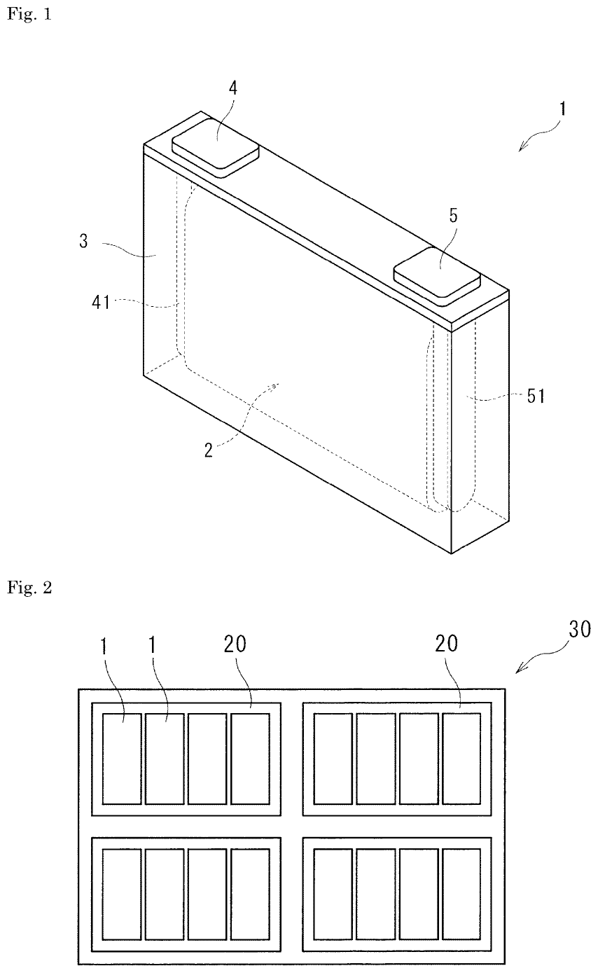

FIG. 1 illustrates a nonaqueous electrolyte energy storage device 1 as an example of prismatic batteries. FIG. 1 is a view illustrating the inside of a case in a perspective manner. An electrode assembly 2 including a positive electrode and a negative electrode wound with a separator interposed therebetween is housed in a prismatic case 3. The positive electrode is electrically connected to a positive electrode terminal 4 via a positive electrode lead 41. The negative electrode is electrically connected to a negative electrode terminal 5 via a negative electrode lead 51.

### Configuration of Energy Storage Apparatus

The energy storage device according to the present embodiment can be mounted as an energy storage unit (battery module) configured with multiple energy storage devices assembled, on power sources for automobiles such as electric vehicles (EVs), hybrid vehicles (HEVs), and plug-in hybrid vehicles (PHEVs), power sources for electronic devices such as personal computers and communication terminals, power sources for power storage, or the like. In this case, the technique of the present invention may be applied to at least one energy storage device included in the energy storage unit.

An energy storage apparatus according to an embodiment of the present invention includes two or more energy storage devices and includes one or more energy storage devices according to an embodiment of the present invention (hereinafter, referred to as “second embodiment”). The technique according to an embodiment of the present invention may be applied to at least one energy storage device included in the energy storage apparatus according to the second embodiment, and the energy storage apparatus may include one energy storage device according to an embodiment of the present invention and include one or more energy storage devices not according to an embodiment of the present invention, or may include two or more energy storage devices according to an embodiment of the present invention. FIG. 2 illustrates an example of an energy storage apparatus 30 obtained by further assembling energy storage units 20 that each have two or more electrically connected energy storage devices 1 assembled. The energy storage apparatus 30 according to the second embodiment may include a busbar (not illustrated) for electrically connecting two or more energy storage devices 1, or a busbar (not illustrated) for electrically connecting two or more energy storage units 20, and the like. The energy storage unit 20 or the energy storage apparatus 30 may include a state monitor (not illustrated) that monitors the state of one or more energy storage devices 1.

### Method for Manufacturing Energy Storage Device

A method for manufacturing the energy storage device according to the present embodiment can be appropriately selected from known methods. The manufacturing method includes, for example, preparing an electrode assembly, preparing a nonaqueous electrolyte, and housing the electrode assembly and the nonaqueous electrolyte in a case. The preparation of the electrode assembly includes: preparing a positive electrode and a negative electrode, and forming an electrode assembly by stacking or winding the positive electrode and the negative electrode with a separator interposed therebetween. The preparation of the negative electrode includes preparing the negative electrode according to an embodiment of the present invention described above.

Housing the nonaqueous electrolyte in the case can be appropriately selected from known methods. For example, in the case of using a nonaqueous electrolyte solution for the nonaqueous electrolyte, the nonaqueous electrolyte solution may be injected from an inlet formed in the case, followed by sealing the inlet.

### Other Embodiments

An energy storage device according to an embodiment of the present invention is not limited to the embodiment mentioned above, and various changes may be made without departing from the scope of the present invention. For example, the configuration according to one embodiment can be added to the configuration according to another embodiment, or a part of the configuration according to one embodiment can be replaced with the configuration according to another embodiment or a well-known technique. Furthermore, a part of the configuration according to one embodiment can be deleted. In addition, a well-known technique can be added to the configuration according to one embodiment.

While the case where the energy storage device is used as a nonaqueous electrolyte secondary battery (for example, lithium ion secondary battery) that can be charged and discharged has been described in the embodiment mentioned above, the type, shape, size, and capacity and the like of the energy storage device are arbitrary. The present invention can also be applied to various secondary batteries, and capacitors such as electric double layer capacitors and lithium ion capacitors.

While the electrode assembly with the positive electrode and the negative electrode stacked or wound with the separator interposed therebetween has been described in the embodiment mentioned above, the electrode assembly may include no separator. For example, the positive electrode and the negative electrode may be brought into direct contact with each other, with a non-conductive layer formed on the active material layer of the positive electrode or negative electrode.

### EXAMPLES

Hereinafter, the present invention is described more specifically with reference to examples. The present invention is not limited to the following Examples.

### Example 1

### Preparation of Negative Electrode

A negative composite paste containing silicon oxide (SiO) as a negative active material, carbon coating the surface thereof, graphite (Gr) as a negative active material, single-walled carbon nanotube (SWCNT) as a conductive agent, styrene-butadiene rubber (SBR) as a rubber-based binder, and carboxymethyl cellulose (CMC) as a thickener at a mass ratio (in terms of solid content) of 72.8:2.2:14.9:0.1:8.8:1.2 and containing water as a dispersion medium was prepared. The negative composite paste was applied to one surface of a copper foil as a negative substrate, dried, and the resultant was pressed to prepare a negative electrode in which a negative active material layer was arranged on one surface of the negative substrate. As the silicon oxide (SiO), the silicon oxide pre-doped with lithium ions in advance was used. The average particle size of the silicon oxide (SiO) was 7 μm.

### Preparation of Positive Electrode

As a positive active material, a lithium transition metal composite oxide having an α-NaFeO₂ type crystal structure and represented by LiNi_{0.5}Co_{0.2}Mn_{0.3}O₂ was used. A positive composite paste containing the positive active material, acetylene black (AB) and SWCNT as a conductive agent, and polyvinylidene fluoride (PVDF) as a binder at a mass ratio (in terms of solid content) of 97.72:1.00:0.09:1.19 and containing N-methylpyrrolidone (NMP) as a dispersion medium was prepared. The positive composite positive composite paste was applied to one surface of an aluminum foil as a positive substrate, dried, and the resultant was pressed to prepare a positive electrode in which a positive active material layer was arranged on one surface of the positive substrate.

### Preparation of Nonaqueous Electrolyte

LiPF₆ was dissolved at a concentration of 1.6 mol/dm³ in a mixed solvent obtained by mixing FEC and TFEMC at a volume ratio of 30:70 to obtain a nonaqueous electrolyte.

### Preparation of Energy Storage Device

The positive electrode and the negative electrode were stacked with a polyolefin microporous membrane as a separator interposed therebetween to prepare an electrode assembly. The separator included a heat resistant layer on the positive electrode side, and the heat resistant layer included heat resistant particles of aluminosilicate. The electrode assembly was housed in a case made of a metal-resin composite film, the nonaqueous electrolyte was injected into the case, and then the case was sealed by heat welding to obtain an energy storage device of Example 1.

### Example 2, Example 3, Examples 5 to 7, Comparative Example 2, and Comparative Example 10

Each energy storage device of Example 2, Example 3, Example 5 to Example 7, Comparative Example 2 and Comparative Example 10 was obtained in the same manner as in Example 1 except that the contents of silicon oxide as a negative active material, graphite and SBR as a rubber-based binder were set as shown in Table 2.

### Example 4

An energy storage device of Example 4 was obtained in the same manner as in Example 1 except that graphite was not used as the negative active material, and the contents of silicon oxide as the negative active material and the single-walled carbon nanotube as the conductive agent were as shown in Table 2.

### Comparative Example 1

An energy storage device of Comparative Example 1 was obtained in the same manner as in Example 1 except that the single-walled carbon nanotube was not used as the conductive agent, and the contents of silicon oxide and graphite as the negative active materials, acetylene black as the conductive agent, and styrene-butadiene rubber as the rubber-based binder were set as shown in Table 2.

### Comparative Example 3

An energy storage device of Comparative Example 3 was obtained in the same manner as in Example 1 except that a single-walled carbon nanotube was not used as the conductive agent, and the contents of silicon oxide and graphite as the negative active materials and acetylene black as the conductive agent were set as shown in Table 2.

### Comparative Example 4

An energy storage device of Comparative Example 4 was obtained in the same manner as in Comparative Example 1 except that acetylene black was used as the conductive agent without using a single-walled carbon nanotube, SBR as the rubber-based binder and CMC as the thickener were not used, sodium polyacrylate (PAANa) was used as the binder, and the contents of silicon oxide and graphite as the negative active materials, acetylene black as the conductive agent, and sodium polyacrylate as the binder were set as shown in Table 2.

### Comparative Examples 5 to 9

Energy storage devices of Comparative Example 5 to Comparative Example 9 were obtained in the same manner as in Comparative Example 4 except that a single-walled carbon nanotube was used as a conductive agent, and the contents of silicon oxide and graphite as negative active materials, a single-walled carbon nanotube as a conductive agent, and sodium polyacrylate as a binder were set as shown in Table 2.

### Initial Charge-Discharge 1

With respect to each of the obtained energy storage devices of Example 1 to Example 7 and Comparative Example 1 to Comparative Example 9, the initial charge-discharge 1 was performed in the following procedures (1) and (2) under an environment of 25° C. An initially (first cycle or second cycle) fully charged (state after constant current constant voltage charge to an end-of-charge voltage set in the energy storage device. In Examples 1 to 7, Examples 12 to 15, and Comparative Examples 1 to 11 described later, the end-of-charge voltage is 4.5 V. In Examples 8 to 11, Examples 16 to 18, and Comparative Example 7-1 described later, the end-of-charge voltage is 4.25 V) energy storage device is discharged at a constant current (state after constant current discharge to an end-of-discharge voltage set in the energy storage device), and the current at which it reaches a fully discharged state (the state after constant current discharge to the end-of-discharge voltage set in the storage element. In Examples and Comparative Examples described later, the current at which the end-of-discharge voltage is 2.5 V) in 10 hours is 0.1 C. The current of 0.1 C can be estimated by calculation from the positive electrode capacity, the negative electrode capacity, the design of the energy storage device, and the like, and the validity of the current of 0.1 C can be confirmed by confirming that the discharge time is about 10 hours when the constant current discharge is performed at the current of 0.1 C in the initial charge-discharge of the energy storage device.

(1) Constant current charge was performed at a charge current of 0.1 C for a charge time of 3 hours. After pause of 1² hours, constant current constant voltage charge was performed at a charge current of 0.1 C and an end-of-charge voltage of 4.5 V. With regard to the charge termination conditions, charge was performed until the charge current reached 0.05C. Thereafter, a pause period of 10 minutes was provided. Thereafter, constant current discharge was performed at a discharge current of 0.1 C and an end-of-discharge voltage of 2.5 V, and then a pause period of 10 minutes was provided.
(2) Thereafter, constant current constant voltage charge was performed at a charge current of 0.2 C and an end-of-charge voltage of 4.5 V. With regard to the charge termination conditions, charge was performed until the charge current reached 0.05C. Thereafter, a pause period of 10 minutes was provided. Thereafter, constant current discharge was performed at a discharge current of 0.1 C and an end-of-discharge voltage of 2.5 V, and then a pause period of 10 minutes was provided.

### Charge-Discharge Cycle Test 1

Next, the following charge-discharge cycle test 1 was performed under an environment of 25° C. Constant current constant voltage charge was performed at a charge current of 0.5 C and an end-of-charge voltage of 4.5 V. With regard to the charge termination conditions, charge was performed until the charge current reached 0.05C. Thereafter, a pause period of 10 minutes was provided. Thereafter, constant current discharge was performed at a discharge current of 0.5 C and an end-of-discharge voltage of 2.5 V, and then a pause period of 10 minutes was provided. The charge, discharge, and pause steps constituted one cycle, and the cycle was performed 500 cycles.

### Capacity Confirmation Test 1

When the charge-discharge cycle test 1 was completed by 300 cycles and 500 cycles, the next capacity confirmation test 1 was performed under an environment of 25° C. Constant current constant voltage charge was performed at a charge current of 0.2 C and an end-of-charge voltage of 4.5 V.

With regard to the charge termination conditions, charge was performed until the charge current reached 0.05C. Thereafter, a pause period of 10 minutes was provided. Thereafter, constant current discharge was performed at a discharge current of 0.1 C and an end-of-discharge voltage of 2.5 V, and then a pause period of 10 minutes was provided.

### Capacity Retention Ratio

The ratio of the discharge capacity after 300 cycles and after 500 cycles obtained in the capacity confirmation test 1 to the discharge capacity obtained in the procedure (2) in the initial charge-discharge test 1 was determined as a capacity retention ratio (%). The results are shown in Table 2.

### Discharge Capacity Per Negative Active Material

A value obtained by dividing the discharge capacity obtained in the initial charge-discharge (2) by the mass of the negative active material included in the region opposite to the positive electrode in the negative electrode is defined as a discharge capacity per negative active material, and this is shown in Table 2.

### Discharge Capacity Per Unit Area of Positive Electrode

The value obtained by dividing the discharge capacity obtained in the initial charge-discharge (2) by the area of the positive electrode is defined as the discharge capacity per unit area of the positive electrode, and this is shown in Table 2.

TABLE 2

| | Content of silicon-based negative | | | | | | | | |
|---|---|---|---|---|---|---|---|---|---|
| | active material (mass %) | | Composition of negative active material layer (mass % | | | | | | |
| | | SiO/ | Silicon-based | | | | | | |
| | SiO/ | (Negative | material | Carbon-based material | | | | | |
| | Negative | active | Negative active | | | | Negative | | |
| | active | material + | material | Conductive agent | | | active | | |
| | material | Conductive | Carbon coat SiO | | | | material | Binder | |
| | layer | agent) | SiO | Carbon | SWCNT | AB | Gr | SBR | PAANa |
| Comparative | 18.7 | 19.4 | 18.7 | 0.6 | 0.0 | 1.9 | 75.5 | 2.1 | — |
| Example 1 | | | | | | | | | |
| Comparative | 58.3 | 64.7 | 58.3 | 1.7 | 0.1 | 0.0 | 29.9 | 8.8 | — |
| Example 2 | | | | | | | | | |
| Example 1 | 72.8 | 80.9 | 72.8 | 22 | 0.1 | 0.0 | 14.9 | 8.8 | — |
| Example 2 | 77.7 | 86.3 | 77.7 | 2.3 | 0.1 | 0.0 | 9.9 | 8.8 | — |
| Example 3 | 82.5 | 91.7 | 82.5 | 2.5 | 0.1 | 0.0 | 4.9 | 8.8 | — |
| Example 4 | 87.1 | 96.8 | 87.1 | 2.6 | 0.3 | 0.0 | 0.0 | 8.8 | — |
| Example 5 | 68.0 | 75.5 | 68.0 | 2.0 | 0.1 | 0.0 | 19.9 | 8.8 | — |
| Comparative | 82.5 | 91.7 | 82.5 | 2.5 | 0.0 | 2.0 | 3.0 | 8.8 | — |
| Example 3 | | | | | | | | | |
| Comparative | 18.4 | 19.4 | 18.4 | 0.6 | 0.0 | 1.9 | 74.1 | — | 5.0 |
| Example 4 | | | | | | | | | |
| Comparative | 58.3 | 64.7 | 58.3 | 1.7 | 0.1 | 0.0 | 29.9 | — | 10.0 |
| Example 5 | | | | | | | | | |
| Comparative | 88.0 | 75.5 | 68.0 | 2.0 | 0.1 | 0.0 | 19.9 | — | 10.0 |
| Example 6 | | | | | | | | | |
| Comparative | 72.8 | 80.9 | 72.8 | 2.2 | 0.1 | 0.0 | 14.9 | — | 10.0 |
| Example 7 | | | | | | | | | |
| Comparativa | 77.7 | 86.3 | 77.7 | 2.3 | 0.1 | 0.0 | 9.9 | — | 10.0 |
| Example 6 | | | | | | | | | |
| Comparative | 82.5 | 91.7 | 82.5 | 2.5 | 0.1 | 0.0 | 4.9 | — | 10.0 |
| Example 9 | | | | | | | | | |
| Example 6 | 82.2 | 86.7 | 82.2 | 2.5 | 0.1 | 0.0 | 10.0 | 4.0 | — |
| Example 7 | 83.2 | 86.8 | 83.2 | 2.5 | 0.1 | 0.0 | 10.0 | 3.0 | — |
| Comparative | 84.1 | 87.0 | 84.1 | 2.5 | 0.1 | 0.0 | 10.0 | 2.1 | — |
| Example 10 | | | | | | | | | |

| | | Evaluation | | | |
|---|---|---|---|---|---|
| | | Discharge | Discharge | | |
| | | capacity | capacity | | |
| | | per | per unit | Capacity retention | |
| | Composition of negative active | negative | area of | ratio after charge- | |
| | material layer (mass % | active | positive | discharge cycle (%) | |
| | Thickener | material | electrode | 300 | 500 |
| | CMC | (mAh/g) | (mAh/cm²) | cycles | cycles |
| Comparative | 1.2 | 442 | 2.79 | 83.3 | 75.4 |
| Example 1 | | | | | |
| Comparative | 1.2 | 802 | 4.05 | 85.5 | 72.4 |
| Example 2 | | | | | |
| Example 1 | 1.2 | 930 | 4.97 | 88.4 | 76.7 |
| Example 2 | 1.2 | 990 | 4.97 | 87.4 | 75.8 |
| Example 3 | 1.2 | 1026 | 5.48 | 88.7 | 79.7 |
| Example 4 | 1.2 | 1078 | 5.43 | 89.0 | 80.2 |
| Example 5 | 1.2 | 888 | 4.60 | 87.2 | 75.5 |
| Comparative | 1.2 | 1035 | 5.49 | 58.4 | 36.3 |
| Example 3 | | | | | |
| Comparative | — | 447 | 2.83 | 75.2 | 64.1 |
| Example 4 | | | | | |
| Comparative | — | 778 | 4.03 | 87.4 | 71.0 |
| Example 5 | | | | | |
| Comparative | — | 898 | 4.44 | 86.8 | 68.9 |
| Example 6 | | | | | |
| Comparative | — | 913 | 4.49 | 75.9 | 52.7 |
| Example 7 | | | | | |
| Comparativa | — | 976 | 4.88 | 64.7 | 44.4 |
| Example 6 | | | | | |
| Comparative | — | 909 | 4.59 | 48.6 | 33.0 |
| Example 9 | | | | | |
| Example 6 | 1.2 | 892 | 5.28 | 89.6 | 78.4 |
| Example 7 | 1.2 | 989 | 5.37 | 84.7 | 73.2 |
| Comparative | 1.2 | 990 | 5.29 | 76.1 | 62.1 |
| Example 10 | | | | | |

As shown in Table 2, in the energy storage devices of Examples 1 to 7 including the negative electrode in which the content of the silicon-based negative active material in the negative active material layer was 68 mass % or more, the content of the rubber-based binder in the negative active material layer was 3.0 mass % or more, and the content of the carbon nanotube in the negative active material layer was 0.4 (n=1 in 0.4×(n2+4n)/(2n+3)) mass % or less, the discharge capacity per negative active material was high, and the decrease in the capacity retention ratio after the charge-discharge cycle was suppressed. Among them, Example 4 in which the content of the silicon-based negative active material was high had a particularly high discharge capacity per negative active material and was excellent in the effect of suppressing the decrease in the capacity retention ratio after the charge-discharge cycle.

On the other hand, in Comparative Example 1, Comparative Example 2, Comparative Example 4 and Comparative Example 5 in which the content of the silicon-based negative active material was less than 68 mass %, Comparative Example 3 in which the content of the silicon-based negative active material was 68 mass % or more and a carbon nanotube was not contained as a conductive agent, and Comparative Examples 6 to 9 in which the content of the silicon-based negative active material was 68 mass % or more and sodium polyacrylate which was not a rubber-based binder was contained as a binder, the discharge capacity per negative active material was lower than those in Examples 1 to 7, or the effect of suppressing the decrease in the capacity retention ratio after the charge-discharge cycle was lower. In Comparative Example 10 in which the content of the silicon-based negative active material was 68 mass % or more and the content of the rubber-based binder in the negative active material layer was less than 3.0 mass %, the effect of suppressing the decrease in the capacity retention ratio after the charge-discharge cycle was low.

### Examples 8 to 11

Each energy storage device of Example 8 to Example 11 was obtained in the same manner as in Example 1 except that hard carbon (HC) was used instead of graphite as a negative active material, the average particle size of silicon oxide as a negative active material was changed to 11 μm, the contents of silicon oxide as a negative active material, HC and SBR as a rubber-based binder were set as shown in Table 3, and the nonaqueous electrolyte was changed to a nonaqueous electrolyte obtained by dissolving LiPF₆ at a concentration of 1.5 mol/dm³ in a mixed solvent obtained by mixing FEC and EMC at a volume ratio of 30:70.

### Initial Charge-Discharge 2

With respect to each of the obtained energy storage devices of Example 8 to Example 11, the initial charge-discharge was performed in the following procedures (3) and (4) under an environment of 25° C.

(3) Constant current charge was performed at a charge current of 0.1 C for a charge time of 3 hours. After pause of 1² hours, constant current constant voltage charge was performed at a charge current of 0.1 C and an end-of-charge voltage of 4.25 V. With regard to the charge termination conditions, charge was performed until the charge current reached 0.05C. Thereafter, a pause period of 10 minutes was provided. Thereafter, constant current discharge was performed at a discharge current of 0.1 C and an end-of-discharge voltage of 2.5 V, and then a pause period of 10 minutes was provided.
(4) Thereafter, constant current constant voltage charge was performed at a charge current of 0.2 C and an end-of-charge voltage of 4.25 V. With regard to the charge termination conditions, charge was performed until the charge current reached 0.05C. Thereafter, a pause period of 10 minutes was provided. Thereafter, constant current discharge was performed at a discharge current of 0.1 C and an end-of-discharge voltage of 2.5 V, and then a pause period of 10 minutes was provided.

Further, initial charge-discharge was performed according to the following procedure (5) under an environment of 45° C.

(5) Constant current constant voltage charge was performed at a charge current of 1.0 C and an end-of-charge voltage of 4.25 V. With regard to the charge termination conditions, charge was performed until the charge current reached 0.05C. Thereafter, a pause period of 10 minutes was provided. Thereafter, constant current discharge was performed at a discharge current of 0.2 C and an end-of-discharge voltage of 2.5 V, and then a pause period of 10 minutes was provided.

### Charge-Discharge Cycle Test 2

Next, the following charge-discharge cycle test 2 was performed under an environment of 45° C. Constant current constant voltage charge was performed at a charge current of 2.0 C and an end-of-charge voltage of 4.25 V. With regard to the charge termination conditions, charge was performed until the charge current reached 0.05C. Thereafter, a pause period of 10 minutes was provided. Thereafter, constant current discharge was performed at a discharge current of 2.0 C and an end-of-discharge voltage of 2.5 V, and then a pause period of 10 minutes was provided. The charge, discharge, and pause steps constituted one cycle, and the cycle was performed 500 cycles.

Capacity Confirmation Test 2 When the charge-discharge cycle test 2 was completed by 300 cycles and 500 cycles, the next capacity confirmation test 2 was performed under an environment of 45° C. Constant current constant voltage charge was performed at a charge current of 1.0 C and an end-of-charge voltage of 4.25 V. With regard to the charge termination conditions, charge was performed until the charge current reached 0.05C. Thereafter, a pause period of 10 minutes was provided. Thereafter, constant current discharge was performed at a discharge current of 0.2 C and an end-of-discharge voltage of 2.5 V, and then a pause period of 10 minutes was provided.

### Capacity Retention Ratio

The ratio of the discharge capacity after 300 cycles and after 500 cycles obtained in the capacity confirmation test 2 to the discharge capacity obtained in the initial charge-discharge (5) was determined as a capacity retention ratio (%). The results are shown in Table 3.

### Discharge Capacity Per Negative Active Material

A value obtained by dividing the discharge capacity obtained in the initial charge-discharge (4) by the mass of the negative active material included in the region opposite to the positive electrode in the negative electrode is defined as a discharge capacity per negative active material, and this is shown in Table 3.

### Discharge Capacity Per Unit Area of Positive Electrode

The value obtained by dividing the discharge capacity obtained in the initial charge-discharge (4) by the area of the positive electrode is defined as the discharge capacity per unit area of the positive electrode, and this is shown in Table 3.

TABLE 3

| | Content of silicon-based negative | | Composition of negative active material layer (mass %) | | | | | | |
|---|---|---|---|---|---|---|---|---|---|
| | active material (mass %) | | Silicon-based | | | | | | |
| | | SiO/ | material | | | | | | |
| | SiO/ | (Negative | Negative | Carbon-based material | | | | | |
| | Negative | active | active | | | | Negative | | |
| | active | material + | material | Conductive agent | | | active | | |
| | material | Conductive | Carbon coat SiO | | | | material | Binder | |
| | layer | agent) | SiO | Carbon | SWCNT | AB | HC | SBR | PAANa |
| Example 8 | 84.5 | 93.9 | 84.5 | 2.5 | 0.1 | 0.0 | 2.9 | 8.8 | — |
| Example 9 | 87.2 | 93.9 | 87.2 | 2.6 | 0.1 | 0.0 | 2.9 | 6.0 | — |
| Example 10 | 89.1 | 94.0 | 89.1 | 2.7 | 0.1 | 0.0 | 2.9 | 4.0 | — |
| Example 11 | 90.1 | 94.0 | 90.1 | 2.7 | 0.1 | 0.0 | 2.9 | 3.0 | — |

| | | Evaluation | | | |
|---|---|---|---|---|---|
| | | Discharge | Discharge | | |
| | | capacity | capacity | | |
| | | per | per unit | Capacity retention | |
| | | negative | area of | ratio after charge- | |
| | Composition of negative active material layer (mass %) | active | positive | discharge cycle (%) | |
| | Thickener | material | electrode | 300 | 500 |
| | CMC | (mAh/g) | (mAh/cm²) | cycles | cycles |
| Example 8 | 1.2 | 1031 | 3.74 | 88.5 | 80.1 |
| Example 9 | 1.2 | 999 | 3.65 | 82.7 | 73.0 |
| Example 10 | 1.2 | 981 | 3.83 | 75.1 | 64.1 |
| Example 11 | 1.2 | 990 | 3.88 | 67.8 | 55.8 |

As shown in Table 3, in the energy storage devices of Example 8 and Example 9 in which the content of the rubber-based binder in the negative active material layer was 6.0 mass % or more, the effect of suppressing the decrease in the capacity retention ratio after the charge discharge cycle was further enhanced.

### Examples 12 to 14 and Comparative Example 11

Each energy storage device of Example 1² to Example 14 and Comparative Example 11 was obtained in the same manner as in Example 1 except that graphite was not used as the negative active material, and the contents of silicon oxide as the negative active material, SWCNT as the conductive agent, and CMC as the thickener were as shown in Table 4.

### Example 15

An energy storage device of Example 15 was obtained in the same manner as in Example 1 except that hard carbon (HC) was used instead of graphite as a negative active material, and the contents of silicon oxide as a negative active material, HC, SWCNT as a conductive agent, and CMC as a thickener were set as shown in Table 4.

### High-Rate Discharge Performance Test

The initial charge-discharge (1) and the initial charge-discharge (2) were performed on each of the obtained energy storage devices of Example 1² to Example 15 and Comparative Example 11, and then the following high-rate discharge performance test was performed under an environment of 25° C. Constant current constant voltage charge was performed at a charge current of 0.2 C and an end-of-charge voltage of 4.5 V. With regard to the charge termination conditions, charge was performed until the charge current reached 0.05 C. A pause period of 10 minutes was provided after charge. Thereafter, constant current discharge was performed at a discharge current of 0.1 C and an end-of-discharge voltage of 2.5 V, and then a pause period of 10 minutes was provided. The obtained discharge capacity was defined as “0.1 C discharge capacity”. Next, constant current constant voltage charge was performed at a charge current of 0.2 C and an end-of-charge voltage of 4.5 V. With regard to the charge termination conditions, charge was performed until the charge current reached 0.05 C. A pause period of 10 minutes was provided after charge. Thereafter, constant current discharge was performed at a discharge current of 1.0 C and an end-of-discharge voltage of 2.5 V, and then a pause period of 10 minutes was provided. The obtained discharge capacity was defined as “1.0 C discharge capacity”.

The percentage of the 0.1 C discharge capacity to the 1.0 C discharge capacity is shown as “high-rate discharge performance (1.0 C/0.1 C (%))” in Table 4.

For each of the energy storage devices of Example 12 to Example 15 and Comparative Example 11, the discharge capacity per unit area of the positive electrode was determined in the same manner as described above. The results are shown in Table 4.

TABLE 4

| | Content of silicon-based negative | | | | | |
|---|---|---|---|---|---|---|
| | active material (mass %) | | Composition of negative active material layer (mass %) | | | |
| | | SiO/ | Silicon-based | | | |
| | SiO/ | (Negative | material | | | |
| | Negative | active | Negative active | Carbon-based material | | |
| | active | material + | material | Conductive agent | | |
| | material | Conductive | Carbon coat SiO | | | |
| | layer | agent) | SiO | Carbon | SWCNT | AB |
| Comparative | 87.1 | 96.5 | 87.1 | 2.6 | 0.5 | 0.0 |
| Example 11 | | | | | | |
| Example 12 | 87.2 | 96.7 | 87.2 | 2.6 | 0.4 | 0.0 |
| Example 13 | 87.3 | 96.8 | 87.3 | 2.6 | 0.3 | 0.0 |
| Example 14 | 87.4 | 96.9 | 87.4 | 2.6 | 0.2 | 0.0 |
| Example 15 | 84.5 | 93.9 | 84.5 | 2.5 | 0.1 | 0.0 |

| | | | | | Evaluation | |
|---|---|---|---|---|---|---|
| | Composition of negative active material layer (mass %) | | | | | Discharge |
| | Carbon-based material | | | | High rate | capacity per |
| | Negative | | | | discharge | unit area of |
| | active | | | | performance | positive |
| | material | Binder | | Thickener | (1.00/0.1 C | electrode |
| | HC | SBR | PAANa | GMC | (%)) | (mAh/cm²) |
| Comparative | 0.0 | 8.8 | — | 1.0 | 80.2 | 5.35 |
| Example 11 | | | | | | |
| Example 12 | 0.0 | 8.8 | — | 1.0 | 83.4 | 5.50 |
| Example 13 | 0.0 | 8.8 | — | 1.0 | 87.3 | 5.40 |
| Example 14 | 0.0 | 8.8 | — | 1.0 | 87.8 | 5.41 |
| Example 15 | 2.9 | 8.8 | — | 1.2 | 87.9 | 5.43 |

As shown in Table 4, in the energy storage devices of Examples 12 to 15 in which the content of a carbon nanotube in the negative active material layer was 0.4 (n=1 in 0.4×(n²+4n)/(2n+3)) mass % or less, a decrease in high rate discharge performance was suppressed as compared with the energy storage device of Comparative Example 11 in which the content of a carbon nanotube was more than 0.4 (n=1 in 0.4×(n²+4n)/(2n+3)) mass %.

### Examples 16 to 18 and Comparative Example 7-1

Each energy storage device of Example 16 to Example 18 and Comparative Example 7-1 was obtained in the same manner as in Example 1 except that the average particle size of silicon oxide as a negative active material was changed to 11 μm, the contents of silicon oxide and graphite as a negative active material, the type and content of the binder, and the content of CMC as a thickener were set as shown in Table 5, and the nonaqueous electrolyte was changed to a nonaqueous electrolyte obtained by dissolving LiPF₆ at a concentration of 1.5 mol/dm³ in a mixed solvent obtained by mixing FEC and EMC at a volume ratio of 30:70.

### Charge-Discharge Cycle Test 3

For each of the energy storage devices of Example 16 to Example 18 and Comparative Example 7-1, the initial charge-discharge (3), (4) and (5) were performed, and then a charge-discharge cycle test 3 was performed. The charge-discharge cycle test 3 was performed in the same manner as in the charge-discharge cycle test 2 except that the number of test cycles was set to 300 cycles. Thereafter, a capacity confirmation test 4 was performed under the same conditions as in the capacity confirmation test 2.

For each of the energy storage devices of Example 16 to Example 18 and Comparative Example 7-1, the ratio of the discharge capacity after 300 cycles obtained in the capacity confirmation test 4 to the discharge capacity obtained in the initial charge-discharge (5) was obtained as a capacity retention ratio (%). The results are shown in Table 5.

TABLE 5

| | Content of silicon-based negative active | | | | | |
|---|---|---|---|---|---|---|
| | material (mass %) | | Composition of negative active material layer (mass %) | | | |
| | | SiO/ | Silicon-based | | | |
| | SiO/ | (Negative | material | | | |
| | Negative | active | Negative active | Carbon-based material | | |
| | active | material + | material | Conductive agent | | |
| | material | Conductive | Carbon coat SiO | | | |
| | layer | agent) | SiO | Carbon | SWCNT | AB |
| Comparative | 72.8 | 80.9 | 72.8 | 2.2 | 0.1 | 0.0 |
| Example 7-1 | | | | | | |
| Example 16 | 72.8 | 85.7 | 72.8 | 2.2 | 0.1 | 0.0 |
| Example 17 | 72.8 | 85.7 | 72.8 | 2.2 | 0.1 | 0.0 |
| Example 18 | 72.8 | 85.7 | 72.8 | 2.2 | 0.1 | 0.0 |

| | | | | | Evaluation |
|---|---|---|---|---|---|
| | | | | | Capacity |
| | Composition of negative active material layer (mass %) | | | | retention ratio |
| | Negative | | | | after charge- |
| | active | | | | discharge cycle |
| | material | Binder | | Thickener | (300 cycles) |
| | Gr | SBR | PAANa | CMC | (%) |
| Comparative | 14.9 | — | 10.0 | — | 67.2 |
| Example 7-1 | | | | | |
| Example 16 | 9.9 | 5.0 | 10.0 | — | 79.2 |
| Example 17 | 9.9 | 10.0 | 5.0 | — | 90.9 |
| Example 18 | 9.9 | 13.8 | — | 1.2 | 90.6 |

As shown in Table 5, in the energy storage devices of Example 17 and Example 18 in which the negative active material layer contained the rubber-based binder as the main component of the binder, the effect of suppressing the decrease in the capacity retention ratio after the charge-discharge cycle was further enhanced as compared with the energy storage device of Comparative Example 7-1 in which the rubber-based binder was not contained and the energy storage device of Example 16 in which the rubber-based binder was contained and not the main component of the binder.

As a result, it was shown that when the negative electrode contains a silicon-based negative active material in which the content in the negative active material layer is 68 mass % or more, a rubber-based binder in which the content in the negative active material layer is 3.0 mass % or more, and a carbon nanotube in an amount of 0.4×(n²+4n)/(2n+3) mass % or less (where n is the number of layers of graphene forming the carbon nanotube.), it is possible to suppress a decrease in capacity retention ratio after a charge-discharge cycle and a decrease in high rate discharge characteristics while increasing the discharge capacity of the energy storage device.

The present invention can be applied to an energy storage device used as a power source for electronic devices such as personal computers and communication terminals, motor vehicles, a flight vehicle, and the like.

Nonaqueous electrolyte secondary batteries typified by lithium ion secondary batteries are often used for electronic devices such as personal computers and communication terminals, motor vehicles, and the like since, because the batteries are high in energy density. The nonaqueous electrolyte secondary battery generally includes a pair of electrodes electrically isolated from each other by a separator, and a nonaqueous electrolyte interposed between the electrodes, and is configured to allow charge transport ions to be transferred between both the electrodes for charge-discharge. Also, capacitors such as lithium ion capacitors and electric double-layer capacitors, energy storage devices with electrolyte solutions other than nonaqueous electrolyte solutions used, and the like are also widely used as energy storage devices other than nonaqueous electrolyte secondary batteries.

JP-A-2015-053152, JP-A-2010-212228 and JP-A-2004-356078 describes an energy storage device in which a silicon-based negative active material (a negative active material containing a silicon element, such as silicon simple substance or silicon oxide) is used as a negative active material. The silicon-based negative active material has a larger electric capacity than a carbon-based negative active material (carbon-based material) such as graphite, and thus is expected as a promising negative active material.

On the other hand, the silicon-based negative active material has large expansion and contraction accompanying charge-discharge. In addition, as the content of the silicon-based negative active material in the negative active material layer increases, the influence of expansion and contraction of the silicon-based negative active material increases, and the bonding state between the silicon-based negative active materials is likely to be impaired when charge-discharge are repeated. Therefore, isolation of the silicon-based negative active material may occur, and the capacity retention ratio of the energy storage device after a charge-discharge cycle may decrease. On the other hand, it has been proposed that a carbon-based material is mixed with the negative active material layer to reduce the content ratio of the silicon-based negative active material. However, when the content ratio of the silicon-based negative active material in the negative active material layer is reduced, the discharge capacity density of the negative electrode is reduced, and a high capacity energy storage device cannot be obtained. In addition, adoption of a high-strength binder such as polyimide or acrylic resin has been proposed. However, the polyimide binder has a problem in practical use, for example, it is necessary to heat the negative electrode to a high temperature under an inert atmosphere in a manufacturing process of the negative electrode in order to obtain the sufficient binding property. In addition, the acrylic resin does not have a sufficient effect on the decrease in the capacity retention ratio after the charge-discharge cycle in the silicon-based negative active material. In addition, it has been proposed to use a carbon nanotube as the conductive agent. However, when many carbon nanotubes are used, high rate discharge performance tends to be deteriorated.

A negative electrode according to an embodiment of the present invention suppresses a decrease in a capacity retention ratio after a charge-discharge cycle and a deterioration in high-rate discharge performance while increasing a discharge capacity of an energy storage device when a silicon-based negative active material is used, and an energy storage device and an energy storage apparatus including such a negative electrode.

A negative electrode according to one aspect of the present invention includes a negative active material layer containing a silicon-based negative active material, a rubber-based binder, and a carbon nanotube, wherein a content of the silicon-based negative active material in the negative active material layer is 68 mass % or more, a content of the rubber-based binder in the negative active material layer is 3.0 mass % or more, and a content of the carbon nanotube in the negative active material layer is 0.4×(n²+4n)/(2n+3) mass % or less (where n is the number of layers of graphene forming the carbon nanotube.).

An energy storage device according to another aspect of the present invention includes the negative electrode according to an aspect of the present invention.

An energy storage apparatus according to another aspect of the present invention includes two or more energy storage devices and one or more energy storage devices according to an aspect of the present invention.

According to one aspect of the present invention, it is possible to provide a negative electrode capable of suppressing a decrease in a capacity retention ratio after a charge-discharge cycle and a decrease in high rate discharge performance while increasing a discharge capacity of an energy storage device when a silicon-based negative active material is used, and an energy storage device and an energy storage apparatus including such a negative electrode.

Obviously, numerous modifications and variations of the present invention are possible in light of the above teachings. It is therefore to be understood that within the scope of the appended claims, the invention may be practiced otherwise than as specifically described herein.

1. A negative electrode for an energy storage device, comprising:
a negative active material layer comprising a silicon-based negative active material, a rubber-based binder, and a carbon nanotube,
wherein a content of the silicon-based negative active material in the negative active material layer is 68 mass % or more, a content of the rubber-based binder in the negative active material layer is 3.0 mass % or more, and a content of the carbon nanotube in the negative active material layer is 0.4×(n²+4n)/(2n+3) mass % or less where n is a number of layers of graphene forming the carbon nanotube.

2. The negative electrode for an energy storage device according to claim 1, wherein a content of the carbon nanotube in the negative active material layer is 0.4 mass % or less.

3. The negative electrode according to claim 1, wherein the negative active material layer further includes a carbon-based material such that a total content of the carbon nanotube and the carbon-based material in the negative active material layer is 22 mass % or less.

4. The negative electrode according to claim 1, wherein a content of the rubber-based binder in the negative active material layer is 6.0 mass % or more.

5. The negative electrode according to claim 1, wherein the carbon nanotube includes a single-walled carbon nanotube.

6. An energy storage device, comprising:
the negative electrode of claim 1.

7. An energy storage apparatus, comprising:
a plurality of energy storage devices including the energy storage device of claim 6.

8. The negative electrode according to claim 2, wherein the negative active material layer further includes a carbon-based material such that a total content of the carbon nanotube and the carbon-based material in the negative active material layer is 22 mass % or less.

9. The negative electrode according to claim 2, wherein a content of the rubber-based binder in the negative active material layer is 6.0 mass % or more.

10. The negative electrode according to claim 2, wherein the carbon nanotube includes a single-walled carbon nanotube.

11. An energy storage device, comprising:
the negative electrode of claim 2.

12. An energy storage apparatus, comprising:
a plurality of energy storage devices including the energy storage device of claim 11.

13. The negative electrode according to claim 1, wherein the negative active material layer includes a second binder such that a content of the rubber-based binder in the negative active material layer is exceeding 50 mass % with respect to a total mass of a binder component in the negative active material layer.

14. The negative electrode according to claim 1, wherein the rubber-based binder in the negative active material layer is styrene-butadiene rubber.

15. The negative electrode according to claim 1, wherein the silicon-based negative active material is silicon oxide, SiOx where 0<x<2.

16. The energy storage device according to claim 6, further comprising:
a nonaqueous electrolyte comprising fluoroethylene carbonate.

17. The negative electrode according to claim 2, wherein the negative active material layer includes a second binder such that a content of the rubber-based binder in the negative active material layer is exceeding 50 mass % with respect to a total mass of a binder component in the negative active material layer.

18. The negative electrode according to claim 2, wherein the rubber-based binder in the negative active material layer is styrene-butadiene rubber.

19. The negative electrode according to claim 2, wherein the silicon-based negative active material is silicon oxide, SiOx where 0<x<2.

20. The energy storage device according to claim 11, further comprising:
a nonaqueous electrolyte comprising fluoroethylene carbonate.
